(19) United States
(12) Patent Application Publication
(10) Pub. No.: US 2010/0028614 A1
(43) Pub. Date: Feb. 4, 2010

(54) METHOD OF FORMING NANOSCALE FEATURES USING SOFT LITHOGRAPHY

(76) Inventors: Anne Shim, Plainstow, NH (US); John Rogers, Champaign, IL (US); Feng Hua, Postdam, NY (US); Keqing Fa, Urbana, IL (US); Paul Bohn, Granger, IN (US)

Correspondence Address: WILLIAMS, MORGAN & AMERSON, 10333 RICHMOND, SUITE 1100, HOUSTON, TX, 77042, US

(21) Appl. No.: 12/281,653

(22) PCT Filed: Mar. 9, 2007
(86) PCT No.: PCT/US07/63644

§ 371 Date: Aug. 4, 2009

Related U.S. Application Data
(60) Provisional application No. 60/786,968, filed on Mar. 29, 2006.

(51) Int. Cl. B32B 3/30; B29C 59/00; B32B 3/10; B32B 5/16

(52) U.S. Cl. 428/172; 264/293; 428/195.1; 428/206; 977/750

(57) ABSTRACT

The present invention provides a method of forming a molecular membrane using soft lithography. The method includes forming a pattern having at least one nanoscale feature in a moldable polymer composition and deploying at least a portion of the pattern adjacent a first substrate.

### BACKGROUND OF THE INVENTION

1. Field of the Invention

This invention relates generally to soft lithography, and, more particularly, to forming nanoscale features using soft lithography.

2. Description of the Related Art

Photolithography is widely used to fabricate electronic, magnetic, mechanical, and optical devices, as well as devices that may be used for biological and chemical analysis. For example, photolithographic techniques may be used to define features and/or configurations of elements of a circuit in a semiconductor device, such as one or more transistors, vias, interconnects, and the like. For another example, photolithography may be used to define structures and/or operating features of optical waveguides and components. For yet another example, photolithography may be used to form structures that may be used to transport fluids and provide sites for chemical reactions and/or analysis including ion separation, reaction catalysis, and the like. Sometimes referred to as a lab-on-a-chip, these structures may be used in semiconductor devices, sensors, DNA separators, molecular membranes, and the like.

In conventional projection mode photolithography, a thin layer of photoresist is applied to a substrate surface and selected portions of the photoresist are exposed to a pattern of light. For example, a mask or masking layer may be used to shield portions of the substrate surface from a light source. The photoresist layer may then be developed so that the exposed (or unexposed) portions of the photoresist layer may be etched. The resolution of conventional photolithography may be determined to a relatively high degree of accuracy, at least in part because conventional photolithography implements well-defined optical techniques. However, the resolution of conventional photolithography may be limited by the wavelength of the light, scattering in the photoresist and/or the substrate, the thickness and/or properties of the photoresist layer, and other effects. Consequently, forming features with sizes (or critical dimensions) less than about 100 nanometers using projection mode photolithography is not generally considered economically feasible. Even if economic considerations are ignored, forming features with sizes (or critical dimensions) less than about 45 nanometers using projection mode photolithography may be virtually impossible.

Next generation lithography (NGL) methods such as e-beam lithography, dip pen lithography, and various nano-imprint techniques may also be used to form structures. For example, e-beam methods may be used to create patterns in polymers, called resists, by exposing the resists to short wavelength UV radiation or electron beams. Exposure to the imaging radiation changes the solubility of the polymer so that the exposed portions of the polymer film may be removed with a solvent. However, producing structures having dimensions less than 100 nm using these techniques is costly and can only be carried out using very special imaging tools and materials. Accordingly, large scale commercial production of devices using these techniques is considered economically unfeasible.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for forming a molecular membrane using soft lithography. The method includes forming a pattern having at least one nanoscale feature in a moldable polymer composition and deploying at least a portion of the pattern adjacent a first substrate.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a technique for forming molecular membranes using soft lithography, in accordance with the present invention;

FIG. 2 conceptually illustrates one exemplary embodiment of a device for driving fluids through a molecular membrane, in accordance with the present invention; and

FIG. 3 shows a fluorescence image of a molecular membrane and two microchannels, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

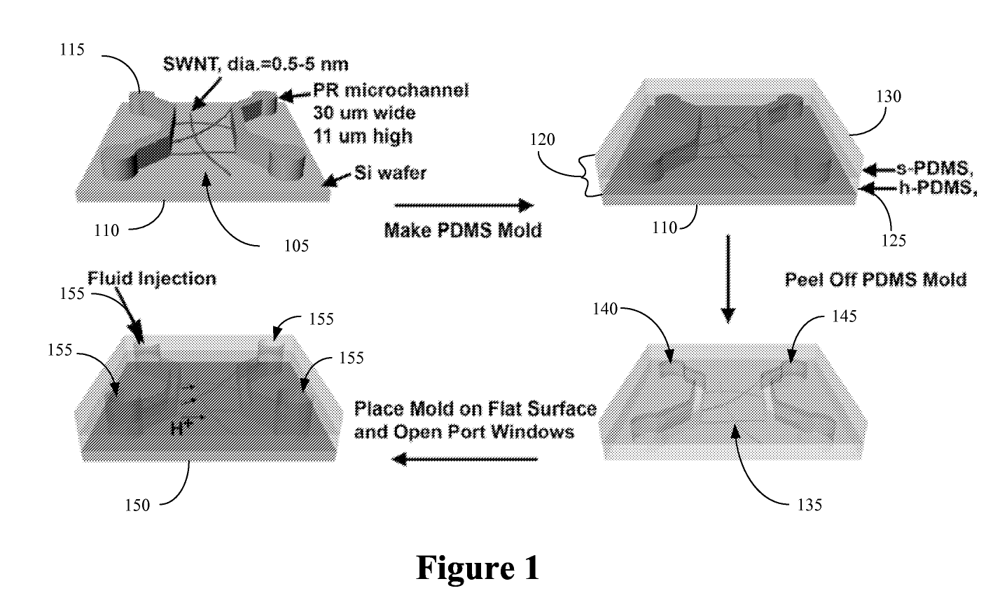

FIG. 1 conceptually illustrates one exemplary embodiment of a technique 100 for forming a molecular membrane including nanoscale features 105 using soft lithography. In the illustrated embodiment, one or more nanoscale features 105 are formed on or adjacent to a substrate 110. As used herein, the term “nanoscale” will be understood to refer to features that are characterized by at least one length scale that is less than about 200 nm. In one embodiment, the nanoscale features have length scales less than about 100 nm. For example, the nanoscale features 105 may have at least one length scale that ranges up to about 5 nm. However, persons of ordinary skill in the art should appreciate that the nanoscale features 105 may also be characterized by other length scales that are substantially longer than 100 nm. For example, nanoscale features 105 that have a cylindrical geometry may have a diameter that ranges up to about 5 nm and a length scale parallel to an axis of the cylinder that is substantially longer than 200 nm.

In one embodiment, the substrate 110 is a silicon wafer and the nanoscale features 105 are single walled carbon nanotubes (SWNT). The substrate 110 may also include a silicon dioxide (SiO₂) layer (not shown) formed on the silicon wafer to promote adhesion and formation of the SWNTs 105. The substrate 110 preferably includes high quality sub-monolayers of small diameter SWNTs 105 that serve as templates from which nanomolds can be constructed. The cylindrical cross sections and high aspect ratios of the SWNTs 105, the atomic scale uniformity of their dimensions over lengths of many microns, their chemical inertness and the ability to grow or deposit them in large quantities over large areas on a range of substrates makes the SWNTs 105 suitable for use in the process of the present invention. However, persons of ordinary skill in the art should appreciate that the substrate 110 and the nanoscale features 105 are not necessarily formed of silicon and single walled nanotubes, respectively, and in alternative embodiments the substrate 110 and/or the nanoscale features 105 may be formed using any materials. For example, the nanoscale features 105 may be formed using double walled nanotubes, nanowires, e-beam written features, purposefully organized structures, and the like.

The SWNTs 105 may be formed using methane based chemical vapor deposition using a relatively high concentration of ferritin catalysts. The SWNTs 105 formed may have diameters of up to about 10 nm and preferably have diameters up to about 5 nm and a coverage of 1-10 tubes/m² on SiO₂/Si wafers. The continuous range of diameters of the tubes and their relatively high, but sub-monolayer, coverage make them ideal for evaluating resolution or dimension limits. The cylindrical geometry of the SWNTs 105 allows their dimensions to be characterized simply by atomic force microscope (AFM) measurements of their heights. The SWNTs 105 are bound to the SiO₂/Si substrate 110 by van der Waals adhesion forces that bind the SWNTs 105 to the substrate 110 with sufficient strength to prevent their removal when a cured polymer mold is peeled away, as will be discussed in more detail below. Preferably the SWNTs 105 have an absence of polymeric residue on large regions allowing for the replication of fine resolution features formed on the substrate 110. The lack of polymeric residue may indicate that the mold did not contaminate the master, thus the features in the mold are due to true replication and not material failure. Optionally, the SWNTs 105 formed on the first substrate may include a layer of a silane applied thereon, to act as a release agent, preventing adhesion of a polymer used to form a mold of the substrate 110.

In the illustrated embodiment, one or more micron-scale features 115 are also formed on or adjacent to the substrate 110. As used herein, the term “micron-scale” will be understood to refer to features that are characterized by at least one length scale that is larger than about 200 nm. For example, the micron-scale features 115 may be microchannels that are approximately 30 microns wide and 11 microns high. In one embodiment, the micron-scale features 115 are formed in contact with at least some of the nanoscale features 105 so that molds formed using the nanoscale features 105 and the micron-scale features 110 may be used to transport fluids, as will be discussed in detail below. The substrate 110 may also include other materials that are deployed in, on, or adjacent to the substrate 110 such as molds made with e-beam lithography, X-ray lithography, a biological material on a plastic sheet, and the like.

One or more curable compositions may be cast and (fully or partially) cured against the substrate 110, the nanoscale features 105, and (if present) the micron-scale features 115, to form a mold 120. In one embodiment, the mold 120 is a composite mold having multiple cured (cross-linked) polymer layers 125, 130. The first layer 125 that is formed against the substrate 110 may be a relatively higher modulus (˜10 MPa) elastomer (i.e., a crosslinked polymer) that is formed by casting and (fully or partially) curing a curable composition including siloxane. The high modulus elastomer (i.e., a crosslinked polymer) formed by (fully or partially) curing a curable composition including siloxane may be referred to as h-PDMS. However, persons of ordinary skill in the art having benefit of the present disclosure should appreciate that, in alternative embodiments, the curable composition can be made using a variety of different methods including the use of silicon containing monomers or polymers with functionality such as epoxy groups, vinyl groups, hydroxy groups. In one embodiment, the curable composition may be prepared by mixing a vinyl functional siloxane and a catalyst. Next, a hydro-functional siloxane may be added and mixed to form the curable composition including siloxane. The curable composition may be cast by spin-casting or otherwise depositing the curable composition on the substrate 110.

In the illustrated embodiment, the curable composition is partially cured, e.g., by heating the curable composition. In one embodiment, a catalyst may induce addition of SiH bonds across vinyl groups in the durable composition, thereby forming SiCH₂—CH₂—Si linkages (also known as hydrosilylation). The presence of at least one moiety with multiple reaction sites in the curable composition allows for 3D crosslinking, which may prohibit relative movement among bonded atoms. The curable composition may be allowed to flow into the relief structure of the master prior to subjecting the curable composition to conditions that will induce crosslinking. The conformability of the siloxane backbone may then allow for replication of fine features, such as the nanoscale features 105 and/or the micron-scale features 115.

An optional second polymer 130 may then be formed adjacent a back surface of the fully or partially cured h-PDMS layer 125. In one embodiment, a physically tough, lower modulus elastomer (s-PDMS) layer 130 is formed adjacent the partially cured h-PDMS layer 125 to make the mold 120 relatively easy to handle. For example, the s-PDMS layer 130 may be formed by casting and curing a curable composition such as Sylgard 184, which is commercially available from Dow Corning Corporation. After formation of the s-PDMS layer 130, the multiple layers 125, 130 of polymer on the substrate 110 may be fully cured to form the composite mold 120. Persons of ordinary skill in the art should, however, appreciate that the second layer 130 is optional and may not be included in some alternative embodiments.

Although the embodiment described above uses curable compositions including siloxane to form the h-PDMS and s-PDMS elastomers, persons of ordinary skill in the art having benefit of the present disclosure should appreciate that the present invention is not limited to forming the mold 120 using these curable compositions. In alternative embodiments, the mold 120 may be formed using curable polyether compositions that form a moldable polymer. Examples of curable polyether compositions include, but are not limited to, curable polyfluorinated polyether compositions, and the like. In other alternative embodiments, the mold 120 may be formed using curable or non-curable resins.

The mold 120 may also be formed using other curable silicone compositions that form a moldable polymer. Examples of curable silicone compositions include, but are not limited to, hydrosilylation-curable silicone compositions, peroxide curable silicone compositions, condensation-curable silicone compositions, epoxy-curable silicone compositions; ultraviolet radiation-curable silicone compositions, and high-energy radiation-curable silicone compositions. In yet other embodiments, hybrid polymers containing copolymers of organic and siloxane polymers may be used either in conjunction with a curable site or by utilizing polymers with high glass transition temperatures.

Curable silicone compositions and methods for their preparation are well known in the art. For example, a suitable hydrosilylation-curable silicone composition typically comprises (i) an organopolysiloxane containing an average of at least two silicon-bonded alkenyl groups per molecule, (ii) an organohydrogensiloxane containing an average of at least two silicon-bonded hydrogen atoms per molecule in an amount sufficient to cure the composition, and (iii) a hydrosilylation catalyst. The hydrosilylation catalyst can be any of the well known hydrosilylation catalysts comprising a platinum group metal, a compound containing a platinum group metal, or a microencapsulated platinum group metal-containing catalyst. Platinum group metals include platinum, rhodium, ruthenium, palladium, osmium and iridium. Preferably, the platinum group metal is platinum, based on its high activity in hydrosilylation reactions.

The hydrosilylation-curable silicone composition can be a one-part composition or a multi-part composition comprising the components in two or more parts. Room-temperature vulcanizable (RTV) compositions typically comprise two parts, one part containing the organopolysiloxane and catalyst and another part containing the organohydrogensiloxane and any optional ingredients. Hydrosilylation-curable silicone compositions that cure at elevated temperatures can be formulated as one-part or multi-part compositions. For example, liquid silicone rubber (LSR) compositions are typically formulated as two-part systems. One-part compositions typically contain a platinum catalyst inhibitor to ensure adequate shelf life.

A suitable peroxide-curable silicone composition typically comprises (i) an organopolysiloxane and (ii) an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aroyl peroxides such as t-butyl perbenzoate, t-butyl peracetate, and t-butyl peroctoate.

A condensation-curable silicone composition typically comprises (i) an organopolysiloxane containing an average of at least two hydroxy groups per molecule; and (ii) a tri- or tetra-functional silane containing hydrolysable Si—O or Si—N bonds. Examples of silanes include alkoxysilanes such as CH3Si(OCH3)3, CH3Si(OCH2CH3)3, CH3Si(OCH2CH2CH3)3, CH3Si[O(CH2)3CH3]3, CH3CH2Si(OCH2CH3)3, C6H5Si(OCH3)3, C6H5CH2Si(OCH3)3, C6H5Si(OCH2CH3)3, CH2=CHSi(OCH3)3, CH2=CHCH2Si(OCH3)3, CF3CH2CH2Si(OCH3)3, CH3Si(OCH2CH2OCH3)3, CF3CH2CH2Si(OCH2CH2OCH3)3, CH2=CHSi(OCH2CH2OCH3)3, CH2=CHCH2Si(OCH2CH2OCH3)3, C6H5Si(OCH2CH2OCH3)3, Si(OCH3)4, Si(OC2H5)4, and Si(OC3H7)4; organoacetoxysilanes such as CH3Si(OCOCH3)3, CH3CH2Si(OCOCH3)3, and CH2=CHSi(OCOCH3)3; organoiminooxysilanes such as CH3Si[O—N═C(CH3)CH2CH3]3, Si[O—N═C(CH3)CH2CH3]4, and CH2=CHSi[O—N═C(CH3)CH2CH3]3; organoacetamidosilanes such as CH₃Si[NHC(═O)CH₃]₃ and C₆H₅Si[NHC(═O)CH₃]₃; aminosilanes such as CH₃Si[NH(s-C₄H₉)]₃ and CH₃Si(NHC₆H₁₁)₃; and organoaminooxysilanes.

A condensation-curable silicone composition can also contain a condensation catalyst to initiate and accelerate the condensation reaction. Examples of condensation catalysts include, but are not limited to, amines; and complexes of lead, tin, zinc, and iron with carboxylic acids. Tin(II) octoates, laurates, and oleates, as well as the salts of dibutyl tin, are particularly useful. The condensation-curable silicone composition can be a one-part composition or a multi-part composition comprising the components in two or more parts. For example, room-temperature vulcanizable (RTV) compositions can be formulated as one-part or two-part compositions. In the two-part composition, one of the parts typically includes a small amount of water.

A suitable epoxy-curable silicone composition typically comprises (i) an organopolysiloxane containing an average of at least two epoxy-functional groups per molecule and (ii) a curing agent. Examples of epoxy-functional groups include 2-glycidoxyethyl, 3-glycidoxypropyl, 4-glycidoxybutyl, 2,(3,4-epoxycyclohexyl)ethyl, 3-(3,4-epoxycyclohexyl)propyl, 2,3-epoxypropyl, 3,4-epoxybutyl, and 4,5-epoxypentyl. Examples of curing agents include anhydrides such as phthalic anhydride, hexahydrophthalic anhydride, tetrahydrophthalic anhydride, and dodecenylsuccinic anhydride; polyamines such as diethylenetriamine, triethylenetetramine, diethylenepropylamine, N-(2-hydroxyethyl)diethylenetriamine, N,N′-di(2-hydroxyethyl)diethylenetriamine, m-phenylenediamine, methylenedianiline, aminoethyl piperazine, 4,4-diaminodiphenyl sulfone, benzyldimethylamine, dicyandiamide, and 2-methylimidazole, and triethylamine; Lewis acids such as boron trifluoride monoethylamine; polycarboxylic acids; polymercaptans; polyamides; and amidoamines.

A suitable ultraviolet radiation-curable silicone composition typically comprises (i) an organopolysiloxane containing radiation-sensitive functional groups and (ii) a photoinitiator. Examples of radiation-sensitive functional groups include acryloyl, methacryloyl, mercapto, epoxy, and alkenyl ether groups. The type of photoinitiator depends on the nature of the radiation-sensitive groups in the organopolysiloxane. Examples of photoinitiators include diaryliodonium salts, sulfonium salts, acetophenone, benzophenone, and benzoin and its derivatives.

A suitable high-energy radiation-curable silicone composition comprises an organopolysiloxane polymer. Examples of organpolyosiloxane polymers include polydimethylsiloxanes, poly(methylvinylsiloxanes), and organohydrogenpolysiloxanes. Examples of high-energy radiation include y-rays and electron beams.

The curable silicone composition of the present invention can comprise additional ingredients. Examples of additional ingredients include, but are not limited to, adhesion promoters, solvents, inorganic fillers, photosensitizers, antioxidants, stabilizers, pigments, and surfactants. Examples of inorganic fillers include, but are not limited to, natural silicas such as crystalline silica, ground crystalline silica, and diatomaceous silica; synthetic silicas such as fused silica, silica gel, pyrogenic silica, and precipitated silica; silicates such as mica, wollastonite, feldspar, and nepheline syenite; metal oxides such as aluminum oxide, titanium dioxide, magnesium oxide, ferric oxide, beryllium oxide, chromium oxide, and zinc oxide; metal nitrides such as boron nitride, silicon nitride, and aluminum nitride, metal carbides such as boron carbide, titanium carbide, and silicon carbide; carbon black; alkaline earth metal carbonates such as calcium carbonate; alkaline earth metal sulfates such as calcium sulfate, magnesium sulfate, and barium sulfate; molybdenum disulfate; zinc sulfate; kaolin; talc; glass fiber; glass beads such as hollow glass microspheres and solid glass microspheres; aluminum trihydrate; asbestos; and metallic powders such as aluminum, copper, nickel, iron, and silver powders.

The silicone composition can be cured by exposure to ambient temperature, elevated temperature, moisture, or radiation, depending on the particular cure mechanism. For example, one-part hydrosilylation-curable silicone compositions are typically cured at an elevated temperature. Two-part hydrosilylation-curable silicone compositions are typically cured at room temperature or an elevated temperature. One-part condensation-curable silicone compositions are typically cured by exposure to atmospheric moisture at room temperature, although cure can be accelerated by application of heat and/or exposure to high humidity. Two-part condensation-curable silicone compositions are typically cured at room temperature; however, cure can be accelerated by application of heat. Peroxide-curable silicone compositions are typically cured at an elevated temperature. Epoxy-curable silicone compositions are typically cured at room temperature or an elevated temperature. Depending on the particular formulation, radiation-curable silicone compositions are typically cured by exposure to radiation, for example, ultraviolet light, gamma rays, or electron beams.

After curing or partially curing, the mold 120 may be removed from the substrate 110. In the illustrated embodiment, the mold 120 includes a molecular membrane 135 corresponding to the nanoscale features 105 formed on the substrate 110. Accordingly, the molecular membrane 135 includes one or more nanoscale features. The mold 120 may also include one or more microchannels 140, 145 that correspond to the micron scale features 115 formed on the substrate 110. In one embodiment, the microchannels 140, 145 are formed proximate the molecular membrane 135 so that liquids may flow between the microchannels 140, 145 by passing through the molecular membrane 135.

After being removed from the substrate 110, the mold 120 may be placed above a surface 150. In one embodiment, the surface 150 is a flat surface of a silicon wafer. For example, the surface 150 may be flat over characteristic length scales associated with the mold 120, such as the characteristic length of one or more single walled nanotubes used to form the nanoscale features 105. However, persons of ordinary skill in the art having benefit of the present disclosure should appreciate that the surface 150 may not necessarily be flat. In alternative embodiments, portions of the surface 150 may be curved, e.g., over length scales that are relatively small compared to the characteristic length of one or more of the nanoscale features 105. Furthermore, the composition of the surface 150 is a matter of design choice and not material to the present invention. In alternative embodiments, any appropriate surface 150 formed of any material may be used.

The mold 120 may adhere to the surface 150 such that any liquid in the molecular membrane 135 and/or the microchannels 140, 145 is substantially constrained to remain within the molecular membrane 135 and/or the microchannels 140, 145. Persons of ordinary skill in the art should appreciate that the term “substantially constrained” is used here to indicate that it may be difficult or impossible to prevent all liquid that may be in the molecular membrane 135 and/or the microchannels 140, 145 from escaping and therefore a portion of the liquid within the molecular membrane 135 and/or the microchannels 140, 145 may escape from the molecular membrane 135 and/or a microchannels 140, 145. However, most of the liquid remains within the molecular membrane 135 and/or the microchannels 140, 145 when the liquid is substantially constrained to remain within the molecular membrane 135 and/or the microchannels 140, 145.

One or more port windows 155 may be opened above one or more portions of the microchannels 140, 145. For example, port windows 155 may be opened over ends of the microchannels 140, 145 to permit fluid to be injected into, or withdrawn from, the microchannels 140, 145. The port windows 155 may be opened using any desirable technique, including etching a portion of the mold 120. Persons of ordinary skill in the art having benefit of the present disclosure should appreciate that the dimensions of the port windows 155 are matters of design choice and are not material to the present invention. For one example, the dimensions of the port windows 155 may correspond to one or more dimensions of a portion of the microchannels 140, 145. In one embodiment, fluids may be provided to one or more port windows 155 and portions of the fluid may be drawn through the microchannels 140, into the molecular membrane 135, into the microchannels 145, and then out through the associated port windows, as will be discussed in detail below.

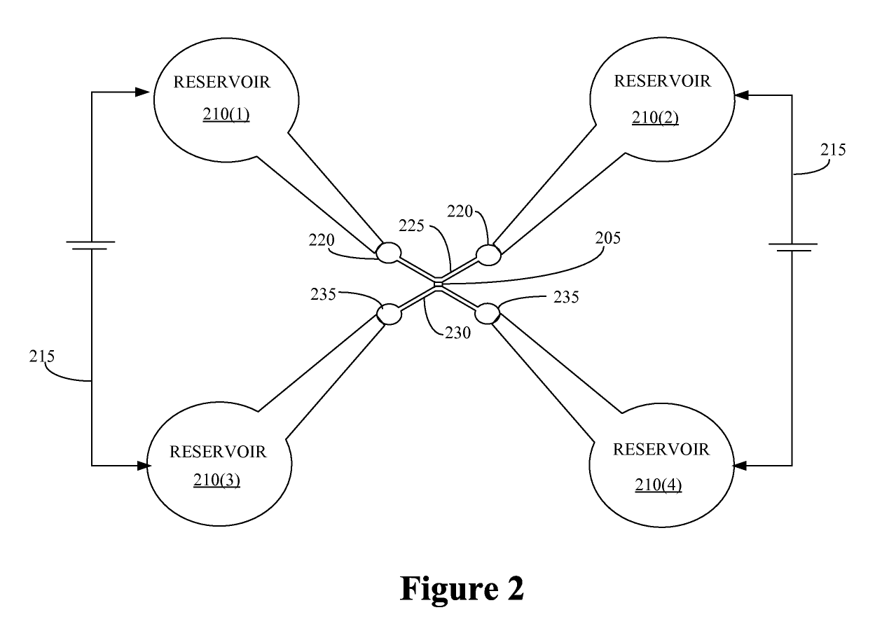

FIG. 2 conceptually illustrates one exemplary embodiment of a device 200 for driving fluids through a molecular membrane 205. In the illustrated embodiment, the molecular membrane 205 includes nanoscale structures formed according to the techniques described above. Fluids may be stored in reservoirs 210(1-4) and provided to, or withdrawn from, the molecular membrane 205. In the illustrated embodiment, a voltage 215 may be applied between the reservoirs 210(1-2) and the reservoirs 210(3-4). The applied voltage 215 may drive fluids from the reservoirs 210(1-2), through port windows 220, and into the microchannels 225. Portions of the fluids may then pass through the molecular membrane 205, into the microchannels 230, and on into the reservoirs 210(3-4) via the port windows 235. For example, protons (i.e., H⁺ ions) may be drawn through the molecular membrane 205 by the applied voltage 215.

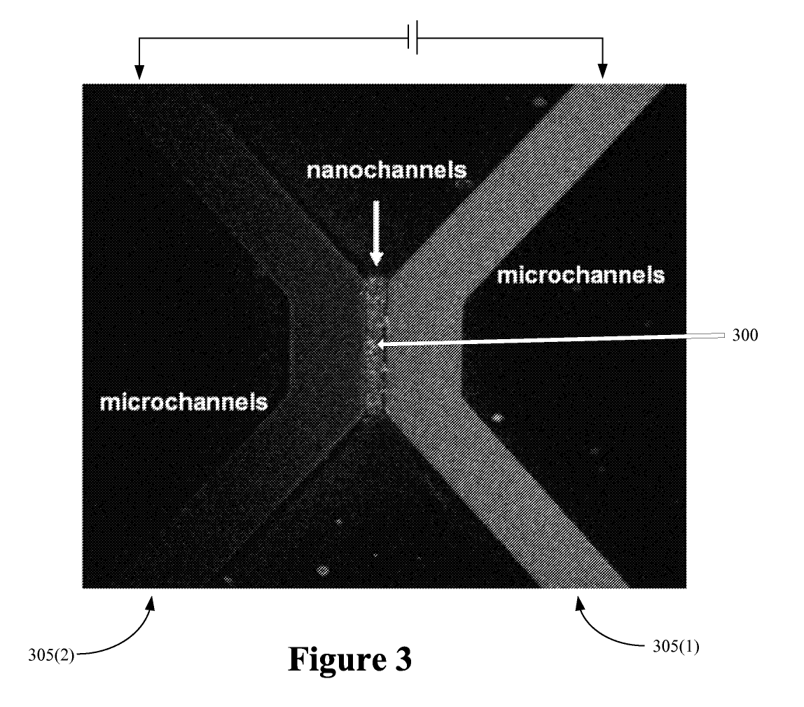

FIG. 3 shows a fluorescence image of a molecular membrane 300 and two microchannels 305(1-2). In the illustrated embodiment, the molecular membrane 300 and the microchannels 305(1-2) are formed using a stamp that was created by casting and curing a PDMS polymer against single-walled carbon nanotubes. The microchannels 305(1-2) were filled with a 0.01 nM Snarf-1 solution with 50 mM phosphate buffered saline (PBS) buffer solution. A voltage was applied across the microchannels 305(1-2) to drive protons through the molecular membrane 300. The changing fluorescence level indicates that protons have been transported from the microchannel 305(1), through the molecular membrane 300, and into the microchannels 305(2).

Although FIGS. 2 and 3 conceptually illustrate nanofluidic channels that may be used to transport fluids across a molecular membrane including nanoscale features, the present invention is not limited to forming nanofluidic channels. Persons of ordinary skill in the art having benefit of the present disclosure should appreciate that embodiments of the techniques for forming nanoscale features in a moldable polymer composition and then deploying the cured polymer or elastomer on a substrate and/or surface may be used in a wide variety of contexts. In various embodiments, moldable polymer compositions including nanoscale features may be employed to transport fluids and/or to provide sites for chemical reactions and/or analysis including ion separation, reaction catalysis, and the like. For example, the cured polymers including nanoscale features may be used to form a lab-on-a-chip-type device, which may be used as portions of semiconductor devices, sensors, DNA separators, and the like.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
forming a pattern comprising at least one nanoscale feature in a moldable polymer composition; and
deploying at least a portion of the pattern adjacent a first substrate.

2. The method of claim 1, wherein forming the pattern comprising said at least one nanoscale feature comprises forming at least one nanoscale feature on a second substrate.

3. The method of claim 2, wherein forming said at least one nanoscale feature on the second substrate comprises forming at least one single walled carbon nanotube on the second substrate.

4. The method of claim 2, wherein forming the pattern comprises casting a first curable composition against the second substrate.

5. The method of claim 4, wherein casting the first curable composition against the second substrate comprises casting a first curable composition comprising a siloxane against the second substrate.

6. The method of claim 4, wherein forming the pattern comprises at least partially curing the first curable composition.

7. The method of claim 4, wherein forming the pattern comprises casting a second curable composition against said at least partially cured first curable composition.

8. The method of claim 7, wherein casting the second curable composition against said at least partially cured first curable composition comprises casting a second curable composition comprising siloxane against the at least partially cured first curable composition.

9. The method of claim 7, wherein forming the pattern comprises curing the first and second curable composition.

10. The method of claim 1, wherein forming the pattern comprises forming at least one micron-scale feature proximate said at least one nanoscale feature.

11. The method of claim 10, wherein forming the pattern comprises forming said at least one micron-scale feature proximate said at least one nanoscale feature such that a fluid may flow from said at least one micron-scale feature to said at least one nanoscale feature.

12. The method of claim 10, wherein forming said at least one micron-scale feature comprises forming at least one microchannel.

13. The method of claim 10, wherein forming said at least one micron-scale feature comprises forming at least one micron-scale feature on the second substrate.

14. The method of claim 1, wherein deploying said portion of the pattern adjacent the first substrate comprises removing the pattern from the second substrate and placing said portion of the pattern adjacent the first substrate.

15. The method of claim 14, wherein placing said portion of the pattern adjacent to the first substrate comprises placing said portion of the pattern adjacent the first substrate such that a fluid is substantially constrained to flow within the pattern.

16. An apparatus, comprising:
a first substrate; and
a pattern comprising at least one nanoscale feature in a moldable polymer composition, the pattern being deployed adjacent the first substrate.

17. The apparatus of claim 16, wherein the at least one nanoscale feature corresponds to at least one single walled carbon nanotube formed on a second substrate.

18. The apparatus of claim 17, wherein the pattern comprises a first cured composition.

19. The apparatus of claim 18, wherein the first cured composition comprises h-PDMS.

21. The apparatus of claim 18, wherein the pattern comprises a second cured composition.

22. The apparatus of claim 21, wherein the second cured composition comprises s-PDMS.

23. The apparatus of claim 16, wherein the pattern comprises at least one micron-scale feature proximate said at least one nanoscale feature.

24. The apparatus of claim 23, wherein the pattern comprises said at least one micron-scale feature proximate said at least one nanoscale feature such that a fluid may flow from said at least one micron-scale feature to said at least one nanoscale feature.

25. The apparatus of claim 23, wherein said at least one micron-scale feature comprises at least one microchannel.

26. The apparatus of claim 16, wherein the pattern is deployed adjacent to the first substrate such that a fluid is substantially constrained to flow within the pattern.

27. A fluid transport system, comprising:
a first substrate;
a molecular membrane comprising at least one nanoscale feature in a moldable polymer composition, the molecular membrane being deployed adjacent the first substrate; and
a plurality of micron-scale channels for providing fluid to the molecular membrane.

28. The system of claim 27, wherein the at least one nanoscale feature corresponds to at least one single walled carbon nanotube formed on a second substrate.

29. The system of claim 28, wherein the molecular membrane comprises a first cured composition.

30. The system of claim 29, wherein the first cured composition comprises a higher modulus organosilicone elastomer.

31. The system of claim 29, wherein the molecular membrane comprises a second cured composition.

32. The system of claim 31, wherein the second cured composition comprises a lower modulus organosilicone elastomer.

33. The system of claim 27, wherein said at least one micron-scale feature comprises at least one microchannel.

34. The system of claim 27, wherein the molecular membrane is deployed adjacent to the first substrate such that a fluid is substantially constrained to flow within the pattern.
